(19) United States
(12) Patent Application Publication
(10) Pub. No.: US 2026/0188288 A1
(43) Pub. Date: Jul. 2, 2026

(54) METHOD FOR TRAINING VOCAL NOTE RECOGNITION MODEL AND VOCAL NOTE RECOGNITION METHOD

(71) Applicant: GUANGZHOU KUGOU COMPUTER TECHNOLOGY CO., LTD., Guangzhou, Guangdong (CN)

(72) Inventors: Chengfang LUO, Guangzhou, Guangdong (CN); Jingxuan WAN, Guangzhou, Guangdong (CN); Chuanyi CHEN, Guangzhou, Guangdong (CN)

(21) Appl. No.: 19/130,084

(22) PCT Filed: Nov. 16, 2022
(86) PCT No.: PCT/CN2022/132325

§ 371 Date: May 14, 2025

(51) Int. Cl. G10H 1/36; G10H 1/00

(52) U.S. Cl. CPC G10H 1/36; G10H 1/0025; G10H 2210/066; G10H 2250/311

(57) ABSTRACT

Provided is a method for training a vocal not recognition model. The method includes: acquiring a labeled vocal audio, a vocal note label corresponding to the labeled vocal audio, a pure vocal audio, and an accompaniment audio; acquiring a trained first network by training a first network based on the labeled vocal audio, the accompaniment audio, and the vocal note label corresponding to the labeled vocal audio, wherein the first network is configured to output a vocal note recognition result based on a synthesized audio generated from the labeled vocal audio and the accompaniment audio; and acquiring the vocal note recognition model by training a second network based on the trained first network, the pure vocal audio, and the accompaniment audio, wherein the second network is configured to output a vocal note recognition result based on a synthesized audio generated from the pure vocal audio and the accompaniment audio.

This application is a U.S. national stage of international application No. PCT/CN2022/132325, filed on Nov. 16, 2022, and entitled “HUMAN VOICE NOTE RECOGNITION MODEL TRAINING METHOD, HUMAN VOICE NOTE RECOGNITION METHOD, AND DEVICE”, the entire content of which is incorporated herein by reference.

### TECHNICAL FIELD

The present disclosure relates to the technical field of artificial intelligence, and in particular to a method for training a vocal note recognition model, a vocal note recognition method, and apparatuses.

### BACKGROUND

Vocal note recognition for a song refers to the process of obtaining the vocal note sequence from the song with accompaniment.

In addition to vocals, songs usually contain accompaniments composed of various musical instruments, and some live songs also include various background noises or reverberations, which pose significant challenges to vocal note recognition for songs.

### SUMMARY

Embodiments of the present disclosure provide a method for training a vocal note recognition model and a vocal note recognition method. The technical solutions are given as follows.

Some embodiments of the present disclosure provided a method for training a vocal note recognition model. The method includes:
acquiring a labeled vocal audio, a vocal note label corresponding to the labeled vocal audio, a pure vocal audio, and an accompaniment audio;
acquiring a trained first network by training a first network based on the labeled vocal audio, the accompaniment audio, and the vocal note label corresponding to the labeled vocal audio, wherein the first network is configured to output a vocal note recognition result corresponding to the labeled vocal audio based on a synthesized audio generated from the labeled vocal audio and the accompaniment audio; and
acquiring the vocal note recognition model by training a second network based on the trained first network, the pure vocal audio, and the accompaniment audio, wherein the second network is configured to output a vocal note recognition result corresponding to the pure vocal audio based on a synthesized audio generated from the pure vocal audio and the accompaniment audio.

Some embodiments of the present disclosure provided a vocal note recognition method. The method includes:
acquiring a target audio with accompaniment, wherein the target audio comprises a vocal and an accompaniment;
acquiring an audio feature of the target audio, wherein the audio feature comprises features of the target audio related in a time-frequency domain;
acquiring a note feature of the target audio by processing the audio feature using a vocal note recognition model, wherein the note feature comprises a feature related to a vocal note of the target audio; and
acquiring a vocal note sequence of the target audio by processing the note feature using the vocal note recognition model;
wherein the vocal note recognition model is acquired by training a second network based on a trained first network, a pure vocal audio and an accompaniment audio; the first network is configured to output a vocal note recognition result corresponding to a labeled vocal audio based on a synthesized audio generated from the labeled vocal audio and the accompaniment audio; the second network is configured to output a vocal note recognition result corresponding to the pure vocal audio based on a synthesized audio generated from the pure vocal audio and the accompaniment audio.

Some embodiments of the present disclosure provided a computer device. The computer device includes a processor and a memory having a computer program stored therein, wherein the processor, when executing the computer program, are caused to perform the method for training the vocal note recognition model as aforementioned, or to perform the vocal note recognition method as aforementioned.

Some embodiments of the present disclosure provided a non-transitory computer-readable storage medium. The computer-readable storage medium has a computer program stored therein, wherein the computer program, when executed by a processor, causes the processor to perform the method for training the vocal note recognition model as aforementioned, or to perform the vocal note recognition method as aforementioned.

Some embodiments of the present disclosure provided a computer program product. The computer program product includes a computer program, wherein the computer program, when read and execute by a processor, causes the processor to perform the method for training the vocal note recognition model as aforementioned, or to perform the vocal note recognition method as aforementioned.

### BRIEF DESCRIPTION OF THE DRAWINGS

FIG. 1 is a schematic diagram of an implementation environment according to some embodiments of the present disclosure;

FIG. 2 is a flowchart of a method for training a vocal note recognition model according to some embodiments of the present disclosure;

FIG. 3 is a flowchart of another method for training a vocal note recognition model according to some embodiments of the present disclosure;

FIG. 4 is a flowchart of still another method for training a vocal note recognition model according to some embodiments of the present disclosure;

FIG. 5 is a schematic diagram of a method for training a vocal note recognition model according to some embodiments of the present disclosure;

FIG. 6 is a flowchart of a vocal note recognition method according to some embodiments of the present disclosure;

FIG. 7 is a schematic diagram of a vocal note recognition model according to some embodiments of the present disclosure;

FIG. 8 is a block diagram of an apparatus for training a vocal note recognition model according to some embodiments of the present disclosure;

FIG. 9 is a block diagram of another apparatus for training a vocal note recognition model according to some embodiments of the present disclosure;

FIG. 10 is a block diagram of a vocal note recognition apparatus according to some embodiments of the present disclosure; and

FIG. 11 is a schematic structural diagram of a computer device according to some embodiments of the present disclosure.

### DETAILED DESCRIPTION

In order to make the purpose, technical solutions and advantages of the present disclosure clearer, the following will describe the embodiments of the present disclosure in further detail in conjunction with the accompanying drawings.

In related technologies, a vocal-accompaniment separation algorithm is first used to isolate the vocal audio from the song, and then a vocal note recognition model is applied to process the vocal audio to obtain the vocal note sequence of the song. However, the above method requires the vocal note recognition based on the vocal-accompaniment separation algorithm, leading to higher computational complexity.

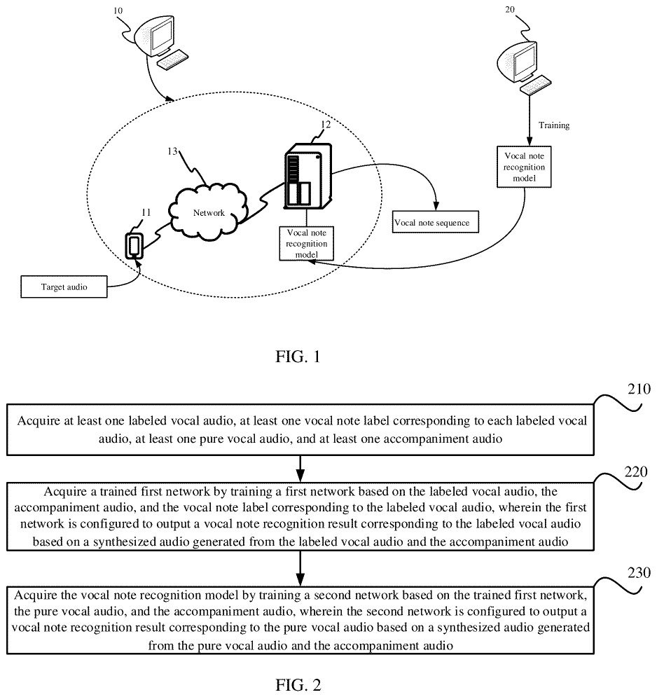

Referring to FIG. 1, which illustrates a schematic diagram of an implementation environment according to some embodiments of the present disclosure, the implementation environment includes: a model-using device 10 and a model-training device 20.

The model-using device 10 is configured to perform the vocal note recognition method in the embodiments of the present disclosure. The model-using device 10 may be a terminal device 11 or a server 12. The terminal device 11 may be an electronic device such as a cellular phone, tablet computer, game console, e-book reader, multimedia playback device, wearable device, personal computer (PC), in-vehicle terminal, and the like. The terminal device 11 is capable of running a target application or a client of the target application. In the embodiments of the present disclosure, the target application refers to an application providing a vocal note recognition function. Optionally, the target application may be a system-level application, such as an operating system or a native application provided by the operating system; or it may be a third-party application, such as a third-party application downloaded and installed by the user. The embodiments of the present disclosure do not limit this.

The server 12 may serve as a backend server for the above-described target application for providing backend services for the target application in the terminal device 11. The server 12 may be a single server, a server cluster composed of multiple servers, or a cloud computing service center. Optionally, the server 12 provides background services for the target application in multiple terminal devices 11 at the same time.

The terminal device 11 and the server 12 may communicate with each other over a network 13. The network 13 may be a wired network or a wireless network.

In the vocal note recognition method according to embodiments of the present disclosure, the execution subject of each step may be a computer device, which refers to an electronic device capable of data computation, processing and storage. For example, the vocal note recognition method may be executed by the terminal device 11 (e.g., the client of the target application installed in the terminal device 11 executes the method), or by the server 12, or it may be executed by the terminal device 11 and the server 12 interactively and cooperatively, which is not limited by the present disclosure. For example, the terminal device 11 acquires the target audio and sends the target audio to the server 12, and the server 12 executes the vocal note recognition method to obtain the vocal note sequence.

The model-training device 20 is configured to perform a method for training a vocal note recognition model in the embodiments of the present disclosure. The model-training device 20 may be a server or a computer device (i.e., an electronic device capable of data computation, processing, and storage). The vocal note recognition model is trained by the model-training device 20, and the trained vocal note recognition model is deployed in the model-using device 10.

Referring to FIG. 2, which illustrates a flowchart of a method for training a vocal note recognition model according to some embodiments of the present disclosure, the method include at least one of the following steps 210 to 230.

In step 210, at least one labeled vocal audio, at least one vocal note label corresponding to each labeled vocal audio, at least one pure vocal audio, and at least one accompaniment audio are acquired.

In some embodiments, a first training sample set, a second training sample set, and a third training sample set are obtained. The first training sample set includes at least one labeled vocal audio and at least one vocal note label corresponding to each labeled vocal audio, the second training sample set includes at least one pure vocal audio, and the third training sample set includes at least one accompaniment audio.

Vocals refer to the segments of a song sung by human voices, such as lyrics and harmonies. Non-vocals refer to the segments of a song other than the vocal segments, such as accompaniment, reverberation, and noise.

Labeled vocal audio refers to a cappella audio without accompaniment where each audio frame contained in the audio is labeled with the corresponding vocal note. The vocal note label corresponding to the labeled vocal audio refers to the vocal note sequence composed of the vocal notes corresponding to each audio frame contained in the labeled vocal audio.

Pure vocal audio refers to audio containing only vocals, separated from the song audio with accompaniment.

Accompaniment audio refers to audio containing only accompaniment, separated from the song audio with accompaniment.

In some embodiments, a vocal-accompaniment separation algorithm is adopted to separate pure vocal audio and accompaniment audio from songs with accompaniment. By performing the above separation operation on multiple songs, multiple pieces of pure vocal audio are obtained for constructing the second training sample set, and multiple pieces of accompaniment audio are obtained for constructing the third training sample set.

In some embodiments, the number of labeled vocal audios contained in the first training sample set is far less than the number of pure vocal audios contained in the second training sample set. Exemplarily, the first training sample set includes 100 labeled vocal audios, and the second training sample set includes 10,000 pure vocal audios.

The present disclosure does not limit the number of accompaniment audios in the third training sample set. For example, the number of accompaniment audios contained in the third training sample set is the same as or different from the number of pure vocal audios contained in the second training sample set.

In step 220, a trained first network is acquired by training a first network based on the labeled vocal audio, the accompaniment audio, and the vocal note label corresponding to the labeled vocal audio, wherein the first network is configured to output a vocal note recognition result corresponding to the labeled vocal audio based on a synthesized audio generated from the labeled vocal audio and the accompaniment audio.

The first network refers to an initialized vocal note recognition model. In some embodiments, the first network is also referred to as a teacher network and the second network is also referred to as a student network.

In some embodiments, the synthesized audio corresponding to the labeled vocal audio is obtained by synthesizing the accompaniment audio with the labeled vocal audio. The first network is trained based on the synthesized audio corresponding to the labeled vocal audio and the vocal note label corresponding to the labeled vocal audio, to obtain the trained first network.

In some embodiments, the synthesized audio corresponding to the labeled vocal audio includes the accompaniment audio and the labeled vocal audio.

In some embodiments, the synthesized audio corresponding to the labeled vocal audio is processed by the first network to obtain the vocal note recognition result corresponding to the labeled vocal audio as a first recognition result. The first network is trained based on the first recognition result and the vocal note label, to obtain the trained first network.

The first recognition result refers to a vocal note sequence of the pure vocal audio obtained by the first network. By inputting the synthesized audio corresponding to the labeled vocal audio to the first network, the first network processes the synthesized audio corresponding to the labeled vocal audio and outputs the first recognition result corresponding to the labeled vocal audio. In some embodiments, the first network is trained based on a loss function to obtain the trained first network. The present disclosure is not limited as to the specific loss function. Exemplarily, a cross-entropy loss function, exponential loss function, log loss function, absolute value loss function, Focal-Loss loss function, and the like may be used.

In some embodiments, the parameters of the first network are adjusted by calculating the loss function value between the first recognition result and the vocal note label, so as to obtain the trained first network.

In some embodiments, the first network is trained by calculating the loss function value between the first recognition result and the vocal note label and adjusting the parameters of the first network.

In some embodiments, the first network includes an input layer, an intermediate layer, and an output layer. The input layer is used to input audio features of the synthesized audio corresponding to the labeled vocal audio; the intermediate layer is used to extract note features of the synthesized audio corresponding to the labeled vocal audio based on the audio features; and the output layer is used to obtain a vocal note sequence of the synthesized audio corresponding to the labeled vocal audio based on the note features.

In some embodiments, the input layer obtains audio features of the synthesized audio corresponding to the labeled vocal audio based on the synthesized audio corresponding to the labeled vocal audio and transmits them to the intermediate layer.

In some embodiments, the input layer directly acquires the audio features of the synthesized audio corresponding to the labeled vocal audio and transmits them to the intermediate layer.

In some embodiments, the output layer is also used to identify a vocal segment and a non-vocal segment of the note feature.

In some embodiments, the first network is trained based on the vocal segment of the note feature, the first recognition result, and the vocal note label, so as to obtain the trained first network.

In some embodiments, the first network is a neural network, and the present disclosure is not limited as to the specific network structure.

In step 230, the vocal note recognition model is acquired by training a second network based on the trained first network, the pure vocal audio, and the accompaniment audio, wherein the second network is configured to output a vocal note recognition result corresponding to the pure vocal audio based on a synthesized audio generated from the pure vocal audio and the accompaniment audio.

In some embodiments, the second network is trained based on the trained first network, the pure vocal audio, and the accompaniment audio.

The second network is the initialized vocal note recognition model. In some embodiments, the second network is a neural network, and the present disclosure is not limited as to the specific network structure.

In some embodiments, the second network and the first network are two networks with the same structure and the same initialization parameters.

In some embodiments, the pure vocal audio is processed by the trained first network to obtain the vocal note recognition result corresponding to the pure vocal audio as a second recognition result; the second recognition result is determined as pseudo-label information corresponding to the pure vocal audio; and the second network is trained based on the pure vocal audio, the accompaniment audio, and the pseudo-label information corresponding to the pure vocal audio.

In some embodiments, the second recognition result is directly identified as pseudo-label information. The scheme is simple and easy to implement with low computational costs.

In some embodiments, the second recognition result is corrected, and the vocal note sequence obtained after the correction is determined as pseudo-label information. The correction of the second recognition result improves the accuracy of the pseudo-label information and further improves the accuracy of the vocal note recognition model obtained after training.

In some embodiments, the synthesized audio corresponding to the pure vocal audio is acquired by synthesizing the accompaniment audio with the pure vocal audio; the second network is trained based on the synthesized audio corresponding to the pure vocal audio and the pseudo-label information.

In some embodiments, the synthesized audio corresponding to the pure vocal audio includes the accompaniment audio and the pure vocal audio.

In some embodiments, the synthesized audio corresponding to the pure vocal audio is processed by the second network to obtain a vocal note recognition result corresponding to the pure vocal audio as a third recognition result; the second network is trained based on the third recognition result and pseudo-label information. The third recognition result refers to a vocal note sequence of the pure vocal audio obtained by the second network. The synthesized audio corresponding to the pure vocal audio is input to the second network, and the second network processes the synthesized audio corresponding to the pure vocal audio and outputs the third recognition result.

In some embodiments, the second network is trained based on a loss function. The present disclosure is not limited as to the specific loss function. Exemplarily, a cross-entropy loss function, exponential loss function, log loss function, absolute value loss function, Focal-Loss loss function, and the like may be used.

In some embodiments, the parameters of the second network are adjusted by calculating the loss function value between the third recognition result and the pseudo-label information, so as to obtain the vocal note recognition model.

In some embodiments, the second network is trained by calculating the loss function value between the third recognition result and the pseudo-label information and adjusting the parameters of the second network.

In some embodiments, the second network includes an input layer, an intermediate layer, and an output layer. The input layer is used to input audio features of the synthesized audio corresponding to the pure vocal audio; the intermediate layer is used to extract note features of the synthesized audio corresponding to the pure vocal audio based on the audio features; and the output layer is used to obtain a vocal note sequence of the synthesized audio corresponding to the pure vocal audio based on the note features.

In some embodiments, the output layer is also used to identify a vocal segment and a non-vocal segment of the note feature.

In some embodiments, the input layer is used to obtain audio features of the synthesized audio corresponding to the pure vocal audio based on the synthesized audio corresponding to the pure vocal audio and transmit them to the intermediate layer.

In some embodiments, the input layer is used to directly obtain the audio features of the synthesized audio corresponding to the pure vocal audio and transmit them to the intermediate layer.

In some embodiments, the second network is trained based on the vocal segment of the note feature, the second recognition result, and the pseudo-label information.

In some embodiments, the loss function for training the first network and the loss function for training the second network may be the same or different, and the present disclosure does not limit this. Exemplarily, both the loss function for training the first network and the loss function for training the second network are cross-entropy loss functions. Exemplarily, the loss function for training the first network is a cross-entropy loss function, and the loss function for training the second network is an absolute value loss function.

A vocal note sequence is a note sequence that characterizes the pitch interval of the vocal and contains the start points, offset points, and pitch values corresponding to different pitch intervals. The offset point denotes the end point of the pitch interval, which may be represented by its offset relative to the start point, hence the term “offset point”. Pitch refers to sounds with different levels of tonality, i.e., the height of a sound, which is one of the fundamental characteristics of the sound. The pitch interval is an audio interval of with a consistent pitch value.

In some embodiments, the vocal note sequence is a musical instrument digital interface (MIDI) sequence.

In some embodiments, the training stop condition is that the second network converges, i.e., the second recognition result corresponding to the pure vocal audio obtained by the second network is infinitely close to the pseudo-label information corresponding to the pure vocal audio.

In some embodiments, it is determined whether the second network satisfies the training stop condition based on the loss function. For example, the training stop condition for the second network is that the loss function value reaches a minimum.

In some embodiments, the training stop condition is set as a predetermined number of iterations, and the training stop condition is satisfied when the predetermined number of iterations is reached. The number of iterations may be calculated based on the execution count of step 230.

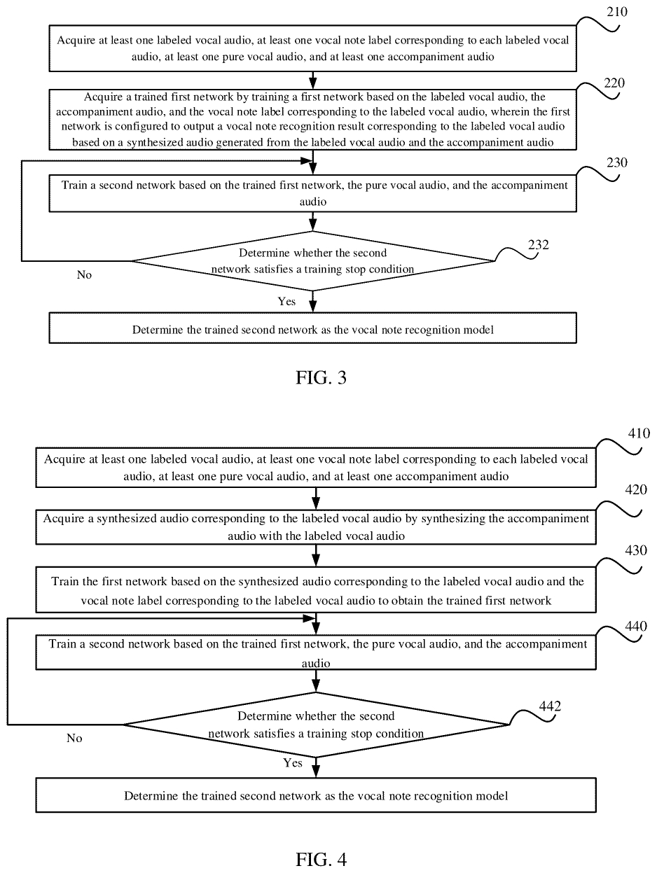

In some embodiments, as shown in FIG. 3, the method further includes a step 232 of determining whether the second network satisfies the training stop condition. If so, the trained second network is determined as the vocal note recognition model; if not, the trained second network is determined as the trained first network, and step 230 above is executed again. That is, in the case that the second network does not satisfy the training stop condition, the trained second network is determined as the trained first network, and the process re-starts from the step of training the second network based on the trained first network, pure vocal audio, and accompaniment audio (step 230).

Exemplarily, the second network satisfies the training stop condition after the n-th training. For the i-th training among the n trainings, the second network after the (i−1)-th training is determined as the first network for the i-th training, and the process re-start again from the step of training the second network based on the trained first network, pure vocal audio, and accompaniment audio (step 230), where n is an integer greater than 2 and i is an integer greater than 1.

In the technical solution according to the embodiments of the present disclosure, the vocal note recognition model obtained by the above training method is capable of directly recognizing a vocal note sequence from the target audio with accompaniment. Thus, during the model usage stage, there is no need to invoke the vocal-accompaniment separation algorithm to extract the vocal audio from the target audio, which reduces the computational complexity of the vocal note recognition. In addition, the present disclosure adopts a semi-supervised training method, in which the first network is trained by a small number of labeled samples, and then the second network is trained by the first network and a large number of unlabeled samples, which allows for training a model with strong generalization performance using only a small amount of labeled samples, reducing the cost of obtaining training samples.

Referring to FIG. 4, which illustrates a flowchart of still another method for training a vocal note recognition model according to some embodiments of the present disclosure, the method may include at least one of the following steps 410 to 440.

In step 410, at least one labeled vocal audio, at least one vocal note label corresponding to each labeled vocal audio, at least one pure vocal audio, and at least one accompaniment audio are acquired.

In some embodiments, a cappella dataset and a song dataset are obtained, the cappella dataset includes at least one cappella audio without accompaniment and a vocal note label corresponding to the cappella audio, and the song dataset includes at least one song audio with accompaniment.

The cappella audio is the vocal audio sung in an unaccompanied environment. The vocal note label corresponding to the cappella audio refers to the vocal note sequence composed of the vocal notes corresponding to each audio frame contained in the cappella audio.

The song audio is audio formed by combining lyrics and accompaniment, which includes both accompaniment and vocals. In some embodiments, the song audio also includes noise and reverberation.

In some embodiments, the labeled vocal audio and the vocal note label corresponding to the labeled vocal audio are generated based on the cappella audio and the vocal note label corresponding to the cappella audio, so as to construct the first training sample set.

In some embodiments, the cappella audio is detected to obtain a silent segment and voiceless segment in the cappella audio; the cappella audio is determined as the labeled vocal audio; the vocal note label corresponding to the labeled vocal audio is generated by deleting a vocal note label corresponding to the silent segment and a vocal note label corresponding to the voiceless segment from the vocal note label corresponding to the cappella audio, so as to construct the first training sample set.

In some embodiments, the cappella audio is detected by a vocal detection algorithm to obtain the silent segment and voiceless segment in the cappella audio.

By adopting the above method, it is ensured that the vocal note label corresponding to the cappella audio has pitch only in the vocal segment and no pitch in the silent segment and voiceless segment, thereby guaranteeing the accuracy of the vocal note label corresponding to the cappella audio.

In some embodiments, the vocal separation operation is performed on the song audio to obtain the vocal audio and the accompaniment audio; the pure vocal audio is generated based on the vocal audio to further construct the second training sample set. The third training sample set is constructed based on the accompaniment audio.

The present disclosure does not limit the specific manner in which the vocal separation operation is performed on the song audio. For example, by means of the vocal-accompaniment separation algorithm, the vocal separation operation is performed on the song audio to obtain the vocal audio and the accompaniment audio.

In some embodiments, the vocal audio is detected to obtain the non-vocal segment in the vocal audio. A initial vocal audio is generated by deleting the non-vocal segment from the vocal audio. And the second training sample set is constructed based on the initial vocal audio.

In some embodiments, the vocal detection algorithm is used to detect non-vocal segment in the vocal audio, which are then removed to generate the initial vocal audio. For example, the vocal detection algorithm identifies non-vocal segments in the vocal audio, and removes those non-vocal segments that exceed 3 seconds in duration to generate the initial vocal audio. Since vocals typically only occupy a portion of general songs and the second training sample set required for training contains a large number of training samples, removing non-vocal segments from initial vocal audio improves training efficiency and saves the storage space needed for the second training sample set.

In some embodiments, all the obtained initial vocal audios are constructed to obtain the second training sample set.

Since the vocal-accompaniment separation algorithm does not guarantee perfect separation of the vocal and accompaniment for each song, it is necessary to clean the initial vocal audio to eliminate the initial vocal audio with residual accompaniment.

In some embodiments, for each audio frame contained in the pure vocal audio, whether the audio frame is a vocal audio frame is detected and an energy of the audio frame is calculated; if the audio frame is not the vocal audio frame and the energy of the audio frame is less than a second threshold, the audio frame is determined to be an invalid frame; if a proportion of invalid frames in the initial vocal audio to a total number of audio frames contained in the initial vocal audio is greater than a third threshold, the initial vocal audio is determined to be an invalid vocal audio; and the pure vocal audio is generated based on the initial vocal audio exclusive of the invalid vocal audio.

In some embodiments, the specific values of the second threshold and the third threshold are set according to actual needs, and the present disclosure is not limited. Exemplarily, for songs of different styles, the values of the second threshold may be different, such as the second threshold for a rock song is higher than the second threshold for an ancient style song.

Exemplarily, the value of the third threshold is set to 30%, and the proportion of invalid frames in the initial vocal audio to the total number of audio frames contained in the initial vocal audio is greater than 30%, the initial vocal audio is determined to be an invalid vocal audio.

In some embodiments, the pure vocal audio is generated based on all of the initial vocal audio exclusive of the invalid vocal audio.

In step 420, a synthesized audio corresponding to the labeled vocal audio is obtained by synthesizing the accompaniment audio with the labeled vocal audio.

In some embodiments, the accompaniment audio is randomly selected from at least one accompaniment audio as a target accompaniment audio. A processed labeled vocal audio is acquired by performing data enhancement processing on the labeled vocal audio, wherein the data enhancement processing includes at least one of adding reverberation or changing a fundamental frequency. And the synthesized audio corresponding to the labeled vocal audio is obtained by synthesizing the target accompaniment audio with the processed labeled vocal audio.

In some embodiments, the accompaniment audio is randomly selected from the third training sample set as the target accompaniment audio.

When sound waves encounter obstacles during propagation, they are reflected by the obstacles, and each reflection causes some energy to be absorbed by the obstacles. As a result, after the sound source stops emitting sound, the sound waves undergo multiple reflections and absorptions before finally fading away. This creates the perception that after the sound source stops, a mixture of sound waves continues for a period of time—this phenomenon is called reverberation. Adding reverberation to the labeled vocal audio can change the sound quality of the labeled vocal audio.

Changing the fundamental frequency refers to adjusting the fundamental frequency of labeled vocal audio within a certain range and the vocal note label corresponding to the labeled vocal audio vocal. The present disclosure does not limit the range of changing the fundamental frequency. For example, the fundamental frequency of labeled human voice audio is adjusted within a range of −200 to +300 cents, and the pitch of the vocal note label corresponding to the labeled vocal audio is modified to match the new fundamental frequency. As an instance, if the fundamental frequency of the labeled vocal audio is increased by 200 cents, the pitch of the vocal note label corresponding to the labeled vocal audio is also increased by 200 cents.

In some embodiments, the fundamental frequency of any one or more of the individual audio frames included in the labeled vocal audio is changed, as well as the pitch of the vocal note label corresponding to that one or more audio frames.

In step 430, based on the synthesized audio corresponding to the labeled vocal audio and the vocal note label corresponding to the labeled vocal audio, the first network is trained to obtain the trained first network.

In some embodiments, the synthesized audio corresponding to the labeled vocal audio is processed by the first network to obtain the vocal note recognition result corresponding to the labeled vocal audio as the first recognition result. A loss function value for the first network is determined based on the first recognition result and the vocal note label. And the trained first network is acquired by adjusting a parameter of the first network based on the loss function value of the first network.

In some embodiments, the first network is trained using a cross-entropy loss function.

In some embodiments, the first network is trained based on the synthesized audio corresponding to the labeled vocal audio and the vocal note label until convergence, and the trained first network is obtained.

In step 440, the vocal note recognition model is acquired by training a second network based on the trained first network, the pure vocal audio, and the accompaniment audio.

In some embodiments, the pure vocal audio is processed by the trained first network to obtain the vocal note recognition result corresponding to the pure vocal audio as a second recognition result. The second recognition result is determined as pseudo-label information corresponding to the pure vocal audio. And the second network is trained based on the pure vocal audio, the accompaniment audio, and the pseudo-label information.

In some embodiments, a fundamental frequency of the pure vocal audio is extracted. Based on the fundamental frequency of the pure vocal audio, the second recognition result is corrected to obtain pseudo-label information corresponding to the pure vocal audio.

In some embodiments, the fundamental frequency of the pure vocal audio is extracted by the fundamental frequency extraction algorithm.

In some embodiments, for each note included in the second recognition result, a pitch difference between the note and a fundamental frequency at an articulation position corresponding to the note is calculated. If the pitch difference is greater than a first threshold, the pitch of the note is corrected to the pitch corresponding to the fundamental frequency at the articulation position corresponding to the note. If the pitch difference is less than or equal to the first threshold, the pitch of the note is kept unchanged.

In some embodiments, the present disclosure is not limited as to the value of the first threshold.

Exemplarily, the first threshold is taken as 3 MIDI values. If the pitch difference is greater than 3 MIDI values, the pitch of the note is corrected to the pitch corresponding to the fundamental frequency at the articulation position corresponding to the note. If the pitch difference is less than or equal to 3 MIDI values, the pitch of the note is kept constant.

For example, the fundamental frequency at the articulation position corresponding to the note is 5 MIDI values, and if the pitch of the note is less than 2 MIDI values, or if the pitch of the note is greater than 8 MIDI values, the pitch of the note is corrected to 5 MIDI values; if the pitch of the note lies between 2 MIDI values and 8 MIDI values, the pitch of the note is kept constant.

By correcting the second recognition result in the above manner, the accuracy of the pseudo-label information corresponding to the pure vocal audio is ensured, making the semi-supervised training method more efficient and stable.

In some embodiments, the synthesized audio corresponding to the pure vocal audio is obtained by synthesizing the accompaniment audio with the pure vocal audio. The synthesized audio corresponding to the pure vocal audio is processed by the second network to obtain the vocal note recognition result corresponding to the pure vocal audio as the third recognition result. And the second network is trained based on the third recognition result and pseudo-label information.

In some embodiments, a loss function value of the second network is determined based on the third recognition result and the pseudo-label information. Based on the loss function value of the second network, the parameter of the second network is adjusted to obtain the vocal note recognition model.

In some embodiments, a cross-entropy loss function is used to train the second network.

In some embodiments, the second network may also perform vocal recognition on the synthesized audio corresponding to the pure vocal audio to obtain a vocal segment and non-vocal segment of the synthesized audio corresponding to the pure vocal audio. And then the second network is trained based on the pure vocal audio and the vocal segment and non-vocal segment of the synthesized audio corresponding to the pure vocal audio.

In some embodiments, a fully-connected layer is adopted to perform the vocal recognition on the synthesized audio corresponding to the pure vocal audio, so as to obtain the vocal segment and non-vocal segment of the synthesized audio corresponding to the pure vocal audio. Exemplarily, Softmax may be employed as a classifier to classify the vocal segment and non-vocal segment of the synthesized audio corresponding to the pure vocal audio.

In some embodiments, the method further includes a step 442 of determining whether the second network satisfies the training stop condition. If so, the trained second network is determined as the vocal note recognition model; if not, the trained second network is determined as the trained first network, and step 440 above is executed again.

Exemplarily, referring to FIG. 5, FIG. 5 illustrates a schematic diagram of a method for training a vocal note recognition model according to some embodiments of the present disclosure.

Step 1: Randomly select the accompaniment audio from the third training sample set (also referred to as dataset 3) 511 as the target accompaniment audio; perform data enhancement processing on the labeled vocal audio in the first training sample set (also referred to as dataset 1) 512 to obtain the processed labeled vocal audio; and synthesize the target accompaniment audio with the processed labeled vocal audio to obtain the synthesized audio corresponding to the labeled vocal audio.

The synthesized audio corresponding to the labeled vocal audio is processed by the teacher network 513, and the vocal note recognition result corresponding to the labeled vocal audio is obtained as the first recognition result. Based on the first recognition result and the vocal note label corresponding to the labeled vocal audio, the loss function value for the teacher network 514 (cross-entropy loss function) is determined. The teacher network 513 is trained based on the loss function value of the teacher network 514 (cross-entropy loss function), and the trained teacher network 521 is obtained.

Step 2: Process the pure vocal audio in the second training sample set (also referred to as dataset 2) 522 by the trained teacher network 521 to obtain the vocal note recognition result corresponding to the pure vocal audio as the second recognition result (also referred to as the pseudo-label corresponding to the pure vocal audio) 523; determine, based on the second recognition result 523, the pseudo-label information (also referred to as a pseudo-label correction corresponding to the pure vocal audio) 524 corresponding to the pure vocal audio.

Step 3: Randomly select the accompaniment audio from the third training sample set 511 as the target accompaniment audio; perform data enhancement processing on the pure vocal audio in the at least one pure vocal audio 522 to obtain the processed pure vocal audio; synthesize the target accompaniment audio with the processed pure vocal audio to obtain the synthesized audio corresponding to the pure vocal audio.

The synthesized audio corresponding to the pure vocal audio is processed using the student network 525 to obtain the vocal note student recognition result corresponding to the pure vocal audio as the third recognition result (also referred to as the prediction corresponding to the pure vocal audio) 526.

Step 4: Determine a loss function value 527 (cross-entropy loss function) of the student network based on the vocal note student recognition result 526 corresponding to the pure vocal audio and the pseudo-label information 524 corresponding to the pure vocal audio; and based on the loss function value 527 (cross-entropy loss function) of the student network, train the student network 525 to obtain the trained student network 531.

INFERENCE: If the trained student network 531 does not satisfy the training stop condition, designate the trained student network 531 as the trained teacher network and repeat the process starting from step 2. That is, the trained teacher network 521 in step 2 is replaced with the trained student network 531 to re-start from step 2.

If the trained student network 531 satisfies the training stop condition, the trained student network 531 is determined as the vocal note recognition model. By inputting a song with accompaniment, the vocal note recognition model processes the song to obtain a vocal note sequence 533 corresponding to the song with accompaniment is obtained.

The technical solution according to the embodiments of the present disclosure further expands the number of training samples based on existing ones through the random data augmentation strategy, which further improves the robustness of the vocal note recognition model.

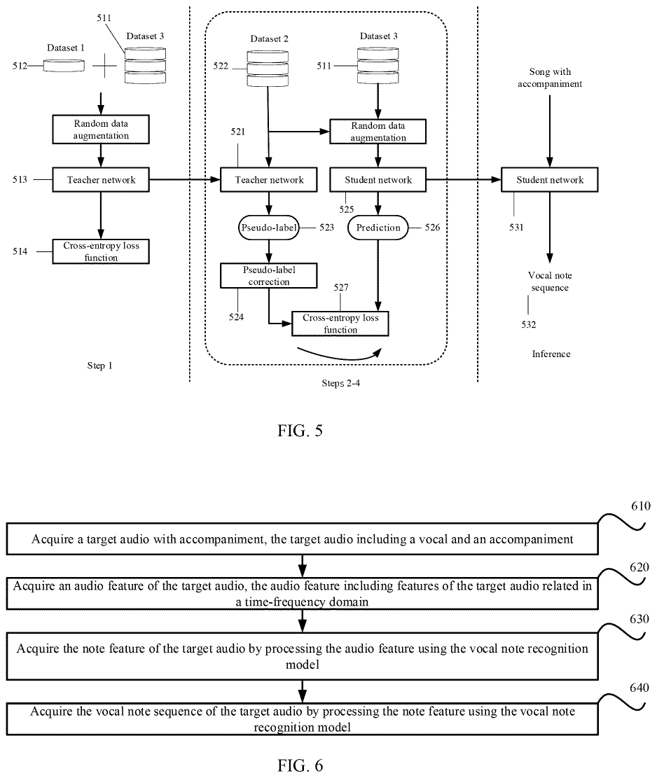

Referring to FIG. 6, which illustrates a flowchart of a vocal note recognition method according to some embodiments of the present disclosure, the method may include at least one of the following steps 610 to 640.

In step 610, a target audio with accompaniment is obtained, the target audio includes a vocal and an accompaniment.

In some embodiments, the target audio further includes noise and reverberation.

In some embodiments, the present disclosure is not limited as to the type of target audio with accompaniment. Exemplarily, the target audio may be a song with accompaniment or a live song recording.

In step 620, an audio feature of the target audio is obtained, the audio feature includes features of the target audio related in a time-frequency domain.

In some embodiments, a time-frequency transform is performed on the target audio to obtain a frequency-domain feature of the target audio; the frequency-domain feature is filtered to obtain an audio feature of the target audio.

The present disclosure does not limit the specific methods of performing time-frequency transforms on the target audio. Exemplarily, a continuous wavelet transform (CWT-ESS) algorithm, a short-time Fourier transform (STFT-ESS) algorithm, an OpenGAN algorithm, and the like may be used.

The present disclosure does not limit the methods for filtering the frequency domain features. Exemplarily, low-pass filtering, high-pass filtering, band-pass filtering, band-stop filtering, and the like may be used.

In step 630, the audio feature is processed by the vocal note recognition model to obtain a note feature of the target audio, the note feature includes a feature related to the vocal note of the target audio.

The vocal note recognition model is obtained by training a second network based on a trained first network, a pure vocal audio, and an accompaniment audio; the first network is configured to output a vocal note recognition result corresponding to the labeled vocal audio based on the synthesized audio generated from the labeled vocal audio and the accompaniment audio; the second network is used to output a vocal note recognition result corresponding to the pure vocal audio based on the synthesized the pure vocal audio and the accompaniment audio.

In some embodiments, for each audio frame contained in the target audio, a first intermediate feature corresponding to the audio frame is acquired by processing the audio feature of the audio frame and contextual information of the audio feature of the audio frame by the vocal note recognition model. A second intermediate feature corresponding to the audio frame is extracted based on the first intermediate feature corresponding to the audio frame. And a note feature corresponding to the audio frame is acquired based on the second intermediate feature corresponding to the audio frame and contextual information of the second intermediate feature corresponding to the audio frame. The note feature of the target audio includes note features corresponding to each of the audio frames contained in the target audio.

The first intermediate feature corresponding to the audio frame includes an audio feature corresponding to the audio frame and contextual information of the audio feature corresponding to the audio frame.

The second intermediate feature corresponding to the audio frame is used to characterize the pitch feature of the audio frame.

The note feature corresponding to the audio frame includes the second intermediate feature corresponding to the audio frame and contextual information of the second intermediate feature corresponding to the audio frame.

Contextual information refers to the association information between the target audio frame and its proximal audio frames. The proximal audio frames refer to the adjacent audio frames and/or nearby audio frames of the target audio frame. The adjacent audio frames are audio frames that have no other audio frames between them and the target audio frame. The nearby audio frames are audio frames within a certain range of the target audio frame. For example, the five audio frames before and after the target audio frame can be called proximal audio frames. The present disclosure does not limit the scope of determining the nearby audio frames.

The present disclosure does not limit the method for obtaining the first intermediate feature corresponding to the audio frame based on the audio feature of the audio frame and contextual information of the audio feature of the audio frame. Exemplarily, the method may be implemented using a recurrent neural network. For example, it may be implemented by a long short term memory network (LSTM) model, or it may be implemented by a gate recurrent unit (GRU) model.

The present disclosure does not limit the method for extracting the second intermediate feature corresponding to the audio frame based on the first intermediate feature corresponding to the audio frame. Exemplarily, this may be realized by a convolutional neural network. For example, it may be realized by a convolutional neural network (CNN), or it may be realized by a residual convolutional neural network (ResNet).

The present disclosure does not limit the method for obtaining the note feature corresponding to the audio frame based on the second intermediate feature corresponding to the audio frame and the contextual information of the second intermediate feature corresponding to the audio frame. Exemplarily, the method may be implemented using a recurrent neural network. For example, it may be implemented by a long short term memory network (LSTM) model, or it may be implemented by a gate recurrent unit (GRU) model.

In step 640, a vocal note sequence of the target audio is obtained by processing the note feature by the vocal note recognition model.

In some embodiments, the vocal note sequence of the target audio is obtained by classifying the note feature of the target audio by the vocal note recognition model.

In some embodiments, the note feature of the target audio is classified based on the pitch of the note feature of the target audio to obtain the vocal note sequence of the target audio.

Exemplarily, the vocal note sequence of the target audio is a MIDI sequence, and a MIDI sequence of the target audio is obtained by classifying the note feature of the target audio of into different MIDI values based on the pitch of the note feature of the target audio.

In some embodiments, the vocal note recognition model includes: an input layer, an intermediate layer, and an output layer.

The input layer is configured to input the audio feature of the target audio.

The middle layer is configured to extract the note feature of the target audio based on the audio feature.

The intermediate layer includes a first intermediate feature extraction layer, a second intermediate feature extraction layer, and a note feature extraction layer.

For each audio frame contained in the target audio, the first intermediate feature extraction layer is configured to obtain the first intermediate feature corresponding to the audio frame based on the audio feature of the audio frame and the contextual information of the audio feature of the audio frame. The second intermediate feature extraction layer is configured to extract the second intermediate feature corresponding to the audio frame based on the first intermediate feature corresponding to the audio frame. The note feature extraction layer is configured to obtain the note feature corresponding to the audio frame based on the second intermediate feature corresponding to the audio frame and the contextual information of the second intermediate feature corresponding to the audio frame.

In some embodiments, the first feature extraction layer is a bidirectional LSTM model, the second feature extraction layer is a CNN model, and the note feature extraction layer is a bidirectional LSTM model. In some embodiments, the second feature extraction layer may be set up with one or more CNN networks constituting a CNN model according to actual needs, and the present disclosure does not limit this. For example, the CNN model is constituted by a 5-layer CNN network.

The output layer is configured to acquire the vocal note sequence of the target audio based on the note feature.

In some embodiments, the output layer is a fully-connected layer. In some embodiments, the output layer uses Softmax as a classifier.

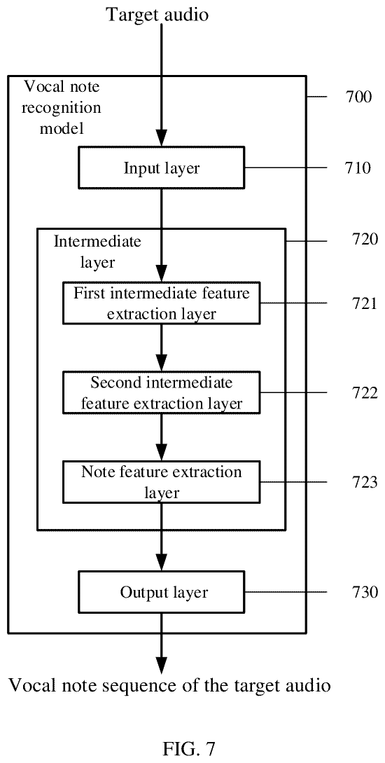

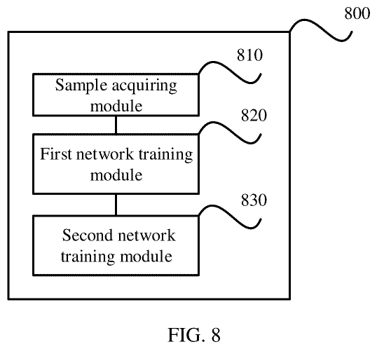

Exemplarily, as shown in FIG. 7, the vocal note recognition model 700 includes an input layer 710, an intermediate layer 720, and an output layer 730. The intermediate layer 720 includes a first intermediate feature extraction layer 721, a second intermediate feature extraction layer 722, and a note feature extraction layer 723.

It should be noted that the embodiments of the vocal note recognition method are based on the same inventive concept as the embodiments of the method for training the vocal note recognition model. For details, reference may be made to the embodiments of the method for training the vocal note recognition model, which is not repeated herein.

In the technical solution according to the embodiments of the present disclosure, the vocal note recognition model recognizes a vocal note sequence of the target note with accompaniment, without calling the vocal accompaniment separation algorithm. This reduces computational complexity and thus production costs, while ensuring that the accuracy is not affected by the vocal accompaniment separation algorithm, thereby guaranteeing the accuracy of the vocal note sequence.

Some embodiments hereinafter illustrate an apparatus for training a vocal node recognition model. The apparatus is adapted to implement the method embodiments of the present disclosure. For details not disclosed in the apparatus embodiments of the present disclosure, reference may be made to the method embodiments of the present disclosure.

Referring to FIG. 8, which illustrates a block diagram of an apparatus 800 for training a vocal note recognition model according to some embodiments of the present disclosure, the apparatus 800 has the function of performing the method for training the vocal node recognition model according to the method embodiments. The function may be implemented by hardware or by hardware executing corresponding software. The apparatus 800 may be the terminal device introduced above or may be set in the terminal device. As shown in FIG. 8, the apparatus 800 may include: a sample acquiring module 810, a first network training module 820, and a second network training module 830.

The sample acquiring module 810 is configured to acquire at least one labeled vocal audio, at least one vocal note label corresponding to each labeled vocal audio, at least one pure vocal audio, and at least one accompaniment audio.

The first network training module 820 is configured to acquire a trained first network by training a first network based on the labeled vocal audio, the accompaniment audio, and the vocal note label corresponding to the labeled vocal audio, wherein the first network is configured to output a vocal note recognition result corresponding to the labeled vocal audio based on a synthesized audio generated from the labeled vocal audio and the accompaniment audio.

The second network training module 830 is configured to acquire the vocal note recognition model by training a second network based on the trained first network, the pure vocal audio, and the accompaniment audio, wherein the second network is configured to output a vocal note recognition result corresponding to the pure vocal audio based on a synthesized audio generated from the pure vocal audio and the accompaniment audio.

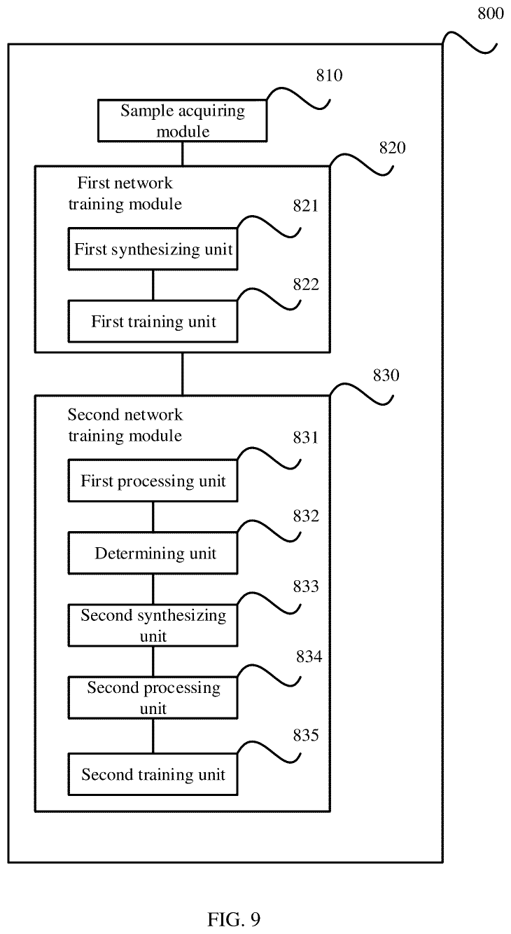

In some embodiments, as shown in FIG. 9, the first network training module 820 includes a first synthesizing unit 821 and a first training unit 822.

The first synthesizing unit 821 is configured to acquire the synthesized audio corresponding to the labeled vocal audio by synthesizing the accompaniment audio with the labeled vocal audio.

The first training unit 822 is configured to acquire the trained first network by training the first network based on the synthesized audio corresponding to the labeled vocal audio and the vocal note label corresponding to the labeled vocal audio.

In some embodiments, the first synthesizing unit 821 is configured to randomly select, from at least one accompaniment audio, an accompaniment audio as a target accompaniment audio; acquire a processed labeled vocal audio by performing data enhancement processing on the labeled vocal audio, wherein the data enhancement processing includes at least one of adding reverberation or changing a fundamental frequency; and acquire the synthesized audio corresponding to the labeled vocal audio by synthesizing the target accompaniment audio with the processed labeled vocal audio.

In some embodiments, the first training unit 822 is configured to acquire the vocal note recognition result corresponding to the labeled vocal audio, as a first recognition result, by processing the synthesized audio corresponding to the labeled vocal audio using the first network; determine a loss function value for the first network based on the first recognition result and the vocal note label; and acquire the trained first network by adjusting a parameter of the first network based on the loss function value of the first network.

In some embodiments, as shown in FIG. 9, the second network training module 830, includes a first processing unit 831, a determining unit 832, a second synthesizing unit 833, a second processing unit 834, and a second training unit 835.

The first processing unit 831 is configured to acquire the vocal note recognition result corresponding to the pure vocal audio, as a second recognition result, by processing the pure vocal audio using the trained first network.

The determining unit 832 is configured to determine the second recognition result as pseudo-label information corresponding to the pure vocal audio.

The second synthesizing unit 833 is configured to acquire the synthesized audio corresponding to the pure vocal audio by synthesizing the accompaniment audio with the pure vocal audio.

The second processing unit 834 is configured to acquire the vocal note recognition result corresponding to the pure vocal audio, as a third recognition result, by processing the synthesized audio corresponding to the pure vocal audio using the second network.

The second training unit 835 is configured to acquire the vocal note recognition model by training the second network based on the third recognition result and the pseudo-label information.

In some embodiments, the determining unit 832 is configured to extract a fundamental frequency of the pure vocal audio; and acquire the pseudo-label information corresponding to the pure vocal audio by correcting the second recognition result based on the fundamental frequency of the pure vocal audio.

In some embodiments, the determining unit 832 is configured to, for each note contained in the second recognition result, calculate a pitch difference between the note and a fundamental frequency at an articulation position corresponding to the note; correct a pitch of the note to a pitch corresponding to the fundamental frequency at the articulation position corresponding to the note in a case where the pitch difference is greater than a first threshold; or keeping the pitch of the note be constant in a case where the pitch difference is less than or equal to the first threshold; and determine a pitch-adjusted second recognition result as the pseudo-label information corresponding to the pure vocal audio.

In some embodiments, the second training unit 835 is configured to determine a loss function value for the second network based on the third recognition result and the pseudo-label information; and acquire the vocal note recognition model by adjusting a parameter of the second network based on the loss function value for the second network.

In some embodiments, the second network training module 830 is configured to determine a trained second network as the trained first network in a case where the second network does not satisfy a training stop condition; and re-starting from the step of training the second network based on the trained first network, the pure vocal audio, and the accompaniment audio.

In some embodiments, the sample acquiring module 810 is configured to: acquire a cappella audio without accompaniment, a vocal note label corresponding to the cappella audio, and a song audio with accompaniment; generate the labeled vocal audio and the vocal note label corresponding to the labeled vocal audio based on the cappella audio and the vocal note label corresponding to the cappella audio; acquire a vocal audio and the accompaniment audio by performing a vocal separation operation on the song audio; and generate the pure vocal audio based on the vocal audio.

In some embodiments, the sample acquiring module 810 is configured to: acquire a silent segment and voiceless segment in the cappella audio by detecting the cappella audio; determine the cappella audio as the labeled vocal audio; and generate the vocal note label corresponding to the labeled vocal audio by deleting a vocal note label corresponding to the silent segment and a vocal note label corresponding to the voiceless segment from the vocal note label corresponding to the cappella audio.

In some embodiments, the sample acquiring module 810 is configured to: acquire a non-vocal segment in the vocal audio by detecting the vocal audio; generate an initial vocal audio by deleting the non-vocal segment from the vocal audio; for each audio frame contained in the pure vocal audio, detect whether the audio frame is a vocal audio frame and calculating an energy of the audio frame; and in a case where the audio frame is not the vocal audio frame and the energy of the audio frame is less than a second threshold, determine the audio frame to be an invalid frame; in a case where a proportion of invalid frames in the initial vocal audio to a total number of audio frames contained in the initial vocal audio is greater than a third threshold, determine the initial vocal audio to be an invalid vocal audio; and generate the pure vocal audio based on the initial vocal audio exclusive of the invalid vocal audio.

In the technical solution according to the embodiments of the present disclosure, the vocal note recognition model obtained by the above training method is capable of directly recognizing a vocal note sequence from the target audio with accompaniment. Thus, during the model usage stage, there is no need to invoke the vocal-accompaniment separation algorithm to extract the vocal audio from the target audio, which reduces the computational complexity of the vocal note recognition. In addition, the present disclosure adopts a semi-supervised training method, in which the first network is trained by a small number of labeled samples, and then the second network is trained by the first network and a large number of unlabeled samples, which allows for training a model with strong generalization performance using only a small amount of labeled samples, reducing the cost of obtaining training samples.

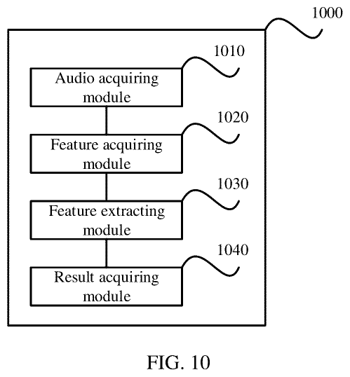

Referring to FIG. 10, which illustrates a block diagram of a vocal note recognition apparatus 1000 according to some embodiments of the present disclosure, the apparatus 1000 has the function of performing the vocal node recognition method according to the method embodiments. The function may be implemented by hardware or by hardware executing corresponding software. The apparatus may be the terminal device introduced above or may be configured in the terminal device. As shown in FIG. 10, the apparatus 1000 may include: an audio acquiring module 1010, a feature acquiring module 1020, a feature extracting module 1030 and a result acquiring module 1040.

The audio acquiring module 1010 is configured to acquire a target audio with accompaniment, wherein the target audio comprises a human voice and an accompaniment.

The feature acquiring module 1020 is configured to acquire an audio feature of the target audio, wherein the audio feature comprises features of the target audio related in a time-frequency domain.

The feature extracting module 1030 is configured to acquire a note feature of the target audio by processing the audio feature using a vocal note recognition model, wherein the note feature comprises a feature related to a vocal note of the target audio.

The result acquiring module 1040 is configured to acquire a vocal note sequence of the target audio by processing the note feature using the vocal note recognition model; wherein the vocal note recognition model is acquired by training a second network based on a trained first network, a pure vocal audio and an accompaniment audio; the first network is configured to output a vocal note recognition result corresponding to a labeled vocal audio based on a synthesized audio generated from the labeled vocal audio and the accompaniment audio; the second network is configured to output a vocal note recognition result corresponding to the pure vocal note frequency based on a synthesized audio generated from the pure vocal audio and the accompaniment audio.

In some embodiments, the feature extracting module 1030 is configured to: for each audio frame contained in the target audio, acquiring a first intermediate feature corresponding to the audio frame by processing the audio feature of the audio frame and contextual information of the audio feature of the audio frame by the vocal note recognition model; extracting a second intermediate feature corresponding to the audio frame based on the first intermediate feature corresponding to the audio frame; and acquiring a note feature corresponding to the audio frame based on the second intermediate feature corresponding to the audio frame and contextual information of the second intermediate feature corresponding to the audio frame; wherein the note feature of the target audio comprises note features corresponding to each of the audio frames contained in the target audio.

In some embodiments, the feature acquiring module 1020 is configured to: acquire a frequency domain feature of the target audio by performing a time-frequency transform on the target audio; and acquire the audio feature of the target audio by filtering the frequency domain feature.

In some embodiments, the result acquiring module 1040 is configured to acquire the vocal note sequence of the target audio by classifying the note feature of the target audio by the vocal note recognition model.

In some embodiments, the vocal note sequence is acquired by the vocal note recognition model. The vocal note recognition model includes: an input layer, an intermediate layer, and an output layer. The input layer is configured to input the audio feature of the target audio, the middle layer is configured to extract the note feature of the target audio based on the audio feature, and the output layer is configured to acquire the vocal note sequence of the target audio based on the note feature.

In the technical solution according to the embodiments of the present disclosure, the vocal note recognition model recognizes a vocal note sequence of the target note with accompaniment, without calling the vocal accompaniment separation algorithm. This reduces computational complexity, while ensuring that the accuracy is not affected by the vocal accompaniment separation algorithm, thereby guaranteeing the accuracy of the vocal note sequence.

It should be noted that when the apparatus provided in the above embodiments implements its functions, the division of the above functional modules is only used as an example. In practical applications, the above functions can be allocated to different functional modules according to actual needs. That is, the internal structure of the apparatus can be divided into different functional modules to complete all or part of the functions described above.

Regarding the apparatus in the above embodiments, the specific ways in which each module performs operations have been described in detail in the embodiments of the relevant method, and will not be described in detail herein.

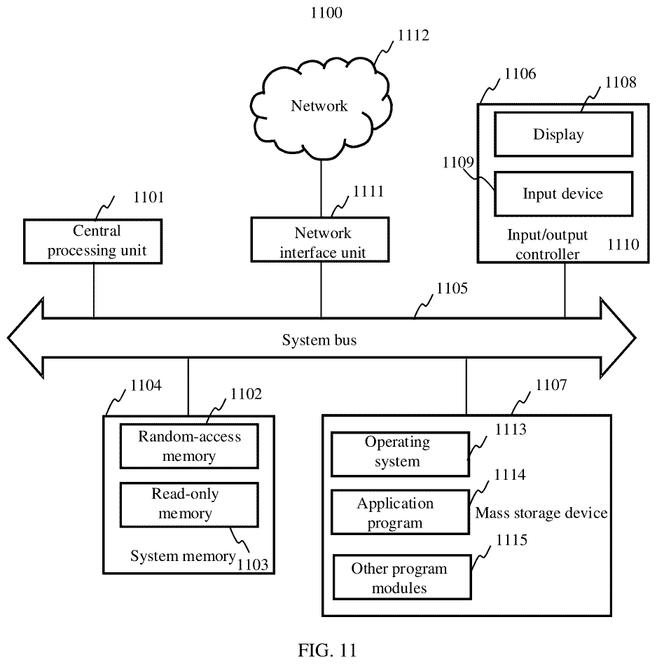

Referring to FIG. 11, which illustrates a schematic structural diagram of a computer device according to some embodiments of the present disclosure, the computer device may be any electronic device having data computation, processing and storage functions. The computer device may be used to implement the method for training a vocal note recognition model provided in the above embodiments, or to implement the vocal note recognition method provided in the above embodiments.

The computer device 1100 includes a central processing unit (CPU) for example, a graphics processing unit (GPU), and a field-programmable gate array (FPGA) 1101; a system memory 1104 including a random-access memory (RAM) 1102 and a read-only memory (ROM) 1103; and a system bus 1105 connecting the system memory 1104 to the central processing unit 1101. The computer device 1100 also includes a basic input/output system (I/O System) 1106 that assists in transferring information between the various devices within the server, and a mass storage device 1107 for storing the operating system 1113, the application program 1114, and other program modules 1115.

In some embodiments, the basic input/output system 1106 includes a display 1108 for displaying information and an input device 1109, such as a mouse, keyboard for users to input information. Here, both the display 1108 and the input device 1109 are connected to the central processing unit 1101 via an input/output controller 1110 that is connected to the system bus 1105. The basic input/output system 1106 may also include an input/output controller 1110 for receiving and processing input from multiple other devices such as a keyboard, a mouse, or an electronic stylus. Similarly, the input/output controller 1110 also provides output to a display, printer, or other type of output device.

The mass storage device 1107 is connected to the central processing unit 1101 via a mass storage controller (not shown) connected to the system bus 1105. The mass storage device 1107 and its associated computer-readable media provide non-transitory storage for the computer device 1100. That is, the mass storage device 1107 may include computer-readable media such as a hard disk or a CD-ROM (Compact Disc Read-Only Memory) drive (not shown).

Without loss of generality, the computer-readable medium may include a computer storage medium and a communication medium. Computer storage media include volatile and non-volatile, removable and non-removable media implemented in any method or technique for storing information such as computer-readable instructions, data structures, program modules, or other data. Computer storage media include a RAM, a ROM, an erasable programmable read-only memory (EPROM), an electrically erasable programmable read-only memory (EEPROM), and an electrically erasable programmable read-only memory (EEPROM), a flash memory or other solid state storages, a CD-ROM, a digital video disc (DVD) or other optical storage, tape cartridge, tape, disk storage or other magnetic storage device. A person skilled in the art may realize that the computer storage medium is not limited to the above-described types. The system memory 1104 and mass storage device 1107 described above may be collectively referred to as memory.

According to some embodiments of the present disclosure, the computer device 1100 may also be connected to a remote computer on a network such as the Internet to run. That is, the computer device 1100 may be connected to the network 1112 via a network interface unit 1111 connected to the system bus 1105. Alternatively, the network interface unit 1111 may be used to connect to other types of networks or remote computer systems (not shown).

The memory has stored therein a computer program. The computer program is loaded and executed by the processor to implement the method for training a vocal note recognition model above-mentioned, or to implement the vocal note recognition method above-mentioned.

In exemplary embodiments, there is also provided a computer-readable storage medium, and the computer-readable storage medium has stored therein a computer program. The computer program, when loaded and executed by a processor, causes the processor to perform the method for training a vocal note recognition model above-mentioned, or to implement the vocal note recognition method above-mentioned.

Optionally, the computer-readable storage medium may include, for example, read-only memory (ROM), random-access memory (RAM), solid state drives (SSD), or optical disk. Among them, the random access memory may include resistance random access memory (ReRAM) and dynamic random access memory (DRAM).

In exemplary embodiments, there is also provided a computer program product, and the computer program product including a computer program. The computer program, when read and executed by a processor, causes the processor to perform the method for training a vocal note recognition model above-mentioned, or to implement the vocal note recognition method above-mentioned.

In the description of embodiments of the present disclosure, the term “corresponding” may indicate a direct or indirect corresponding relationship between the two, or an associated relationship between the two, or a relationship between instructing and being instructed, configuring and being configured, and the like.

The terms used in the present disclosure are for the purpose of describing specific embodiments only and are not intended to limit the present disclosure. The singular forms “a,” “an,” and “the” used in the present disclosure and the appended claims are also intended to include the plural forms, unless the context clearly indicates otherwise. It should be understood that the term “a plurality of” mentioned herein means two or more. The term “and/or” describes association relations among associated objects, and may indicate three relationships. For example, “A and/or B” may indicate that A exists alone, or A and B exist simultaneously, or B exists alone. The character “/” generally indicates that the context associated objects are an “OR” relationship.

In addition, the step numbering described herein only exemplarily shows one possible execution sequence among the steps. In some other embodiments, the above steps may be executed out of the numbering sequence, for example, two steps with different numbers are executed at the same time, or two steps with different numbers are executed in the reverse order of the drawing, which is not limited by the embodiments of the present disclosure.

In addition, the embodiments provided herein may be combined in any combination to form new embodiments, which are within the protection scope of the present disclosure.

It should be appreciated by those skilled in the art that, in one or more of the above embodiments, the functions described in the embodiments of the present disclosure may be implemented using hardware, software, firmware, or any combination thereof. When implemented using software, the functions may be stored in a computer-readable medium or transmitted as one or more instructions or code on a computer-readable medium. Computer-readable media include computer storage media and communication media, wherein communication media include any medium that facilitates the transmission of a computer program from one location to another. The storage medium may be any available medium that can be accessed by a general-purpose or special-purpose computer.

The foregoing is merely exemplary embodiments of the present disclosure, and not intended to limit the present disclosure. Within the spirit and principles of the present disclosure, any modifications, equivalent substitutions, improvements, etc., are within the protection scope of the present disclosure.

1. A method for training a vocal note recognition model, comprising:
acquiring a labeled vocal audio, a vocal note label corresponding to the labeled vocal audio, a pure vocal audio, and an accompaniment audio;
acquiring a trained first network by training a first network based on the labeled vocal audio, the accompaniment audio, and the vocal note label corresponding to the labeled vocal audio, wherein the first network is configured to output a vocal note recognition result corresponding to the labeled vocal audio based on a synthesized audio generated from the labeled vocal audio and the accompaniment audio; and
acquiring the vocal note recognition model by training a second network based on the trained first network, the pure vocal audio, and the accompaniment audio, wherein the second network is configured to output a vocal note recognition result corresponding to the pure vocal audio based on a synthesized audio generated from the pure vocal audio and the accompaniment audio.

2. The method according to claim 1, wherein acquiring the trained first network by training the first network based on the labeled vocal audio, the accompaniment audio, and the vocal note label corresponding to the labeled vocal audio comprises:
acquiring the synthesized audio corresponding to the labeled vocal audio by synthesizing the accompaniment audio with the labeled vocal audio; and
acquiring the trained first network by training the first network based on the synthesized audio corresponding to the labeled vocal audio and the vocal note label corresponding to the labeled vocal audio.

3. The method according to claim 2, wherein acquiring the synthesized audio corresponding to the labeled vocal audio by synthesizing the accompaniment audio with the labeled vocal audio comprises:
randomly selecting, from at least one accompaniment audio, an accompaniment audio as a target accompaniment audio;
acquiring a processed labeled vocal audio by performing data enhancement processing on the labeled vocal audio, wherein the data enhancement processing comprises at least one of adding reverberation or changing a fundamental frequency; and
acquiring the synthesized audio corresponding to the labeled vocal audio by synthesizing the target accompaniment audio with the processed labeled vocal audio.

4. The method according to claim 2, wherein the acquiring the trained first network by training the first network based on the synthesized audio corresponding to the labeled vocal audio and the vocal note label corresponding to the labeled vocal audio comprises:
acquiring the vocal note recognition result corresponding to the labeled vocal audio, as a first recognition result, by processing the synthesized audio corresponding to the labeled vocal audio using the first network;
determining a loss function value for the first network based on the first recognition result and the vocal note label; and
acquiring the trained first network by adjusting a parameter of the first network based on the loss function value of the first network.

5. The method according to claim 1, wherein acquiring the vocal note recognition model by training the second network based on the trained first network, the pure vocal audio, and the accompaniment audio comprises:
acquiring the vocal note recognition result corresponding to the pure vocal audio, as a second second recognition result, by processing the pure vocal audio using the trained first network;
determining the second recognition result as pseudo-label information corresponding to the pure vocal audio;
acquiring the synthesized audio corresponding to the pure vocal audio by synthesizing the accompaniment audio with the pure vocal audio;
acquiring the vocal note recognition result corresponding to the pure vocal audio, as a third recognition result, by processing the synthesized audio corresponding to the pure vocal audio using the second network; and
acquiring the vocal note recognition model by training the second network based on the third recognition result, and the pseudo-label information.

6. The method according to claim 5, wherein determining the second recognition result as the pseudo-label information corresponding to the pure vocal audio comprises:
extracting a fundamental frequency of the pure vocal audio; and
acquiring the pseudo-label information corresponding to the pure vocal audio by correcting the second recognition result based on the fundamental frequency of the pure vocal audio.

7. The method according to claim 6, wherein acquiring the pseudo-label information corresponding to the pure vocal audio by correcting the second recognition result based on the fundamental frequency of the pure vocal audio comprises:
for each note contained in the second recognition result, calculating a pitch difference between the note and a fundamental frequency at an articulation position corresponding to the note;
correcting a pitch of the note to a pitch corresponding to the fundamental frequency at the articulation position corresponding to the note in a case where the pitch difference is greater than a first threshold; or keeping the pitch of the note be constant in a case where the pitch difference is less than or equal to the first threshold; and
determining a pitch-adjusted second recognition result as the pseudo-label information corresponding to the pure vocal audio.

8. The method according to claim 5, wherein acquiring the vocal note recognition model by training the second network based on the third recognition result and the pseudo-label information comprises:
determining a loss function value for the second network based on the third recognition result and the pseudo-label information; and
acquiring the vocal note recognition model by adjusting a parameter of the second network based on the loss function value for the second network.

9. The method according to claim 1, further comprising:
determining a trained second network as the trained first network in a case where the second network does not satisfy a training stop condition; and
re-starting from the step of training the second network based on the trained first network, the pure vocal audio, and the accompaniment audio.

10. The method according to claim 1, wherein acquiring the labeled vocal audio, the vocal note label corresponding to the labeled vocal audio, the pure vocal audio, and the accompaniment audio comprises:
acquiring a cappella audio without accompaniment, a vocal note label corresponding to the cappella audio, and a song audio with accompaniment;
generating the labeled vocal audio and the vocal note label corresponding to the labeled vocal audio based on the cappella audio and the vocal note label corresponding to the cappella audio;
acquiring a vocal audio and the accompaniment audio by performing a vocal separation operation on the song audio; and
generating the pure vocal audio based on the vocal audio.

11. The method according to claim 10, wherein generating the labeled vocal audio and the vocal note label corresponding to the labeled vocal audio based on the cappella audio and the vocal note label corresponding to the cappella audio comprises:
acquiring a silent segment and voiceless segment in the cappella audio by detecting the cappella audio;
determining the cappella audio as the labeled vocal audio; and
generating the vocal note label corresponding to the labeled vocal audio by deleting a vocal note label corresponding to the silent segment and a vocal note label corresponding to the voiceless segment from the vocal note label corresponding to the cappella audio.

12. The method according to claim 10, wherein the generating the pure vocal audio based on the vocal audio comprises:
acquiring a non-vocal segment in the vocal audio by detecting the vocal audio;
generating an initial vocal audio by deleting the non-vocal segment from the vocal audio;
for each audio frame contained in the pure vocal audio, detecting whether the audio frame is a vocal audio frame and calculating an energy of the audio frame;
in a case where the audio frame is not the vocal audio frame and the energy of the audio frame is less than a second threshold, determining the audio frame to be an invalid frame; and in a case where a proportion of invalid frames in the initial vocal audio to a total number of audio frames contained in the initial vocal audio is greater than a third threshold, determining the initial vocal audio to be an invalid vocal audio; and
generating the pure vocal audio based on the initial vocal audio exclusive of the invalid vocal audio.

13. A vocal note recognition method, comprising:
acquiring a target audio with accompaniment, wherein the target audio comprises a vocal and an accompaniment;
acquiring an audio feature of the target audio, wherein the audio feature comprises features of the target audio related in a time-frequency domain;
acquiring a note feature of the target audio by processing the audio feature using a vocal note recognition model, wherein the note feature comprises a feature related to a vocal note of the target audio; and
acquiring a vocal note sequence of the target audio by processing the note feature using the vocal note recognition model;
wherein the vocal note recognition model is acquired by training a second network based on a trained first network, a pure vocal audio and an accompaniment audio; the first network is configured to output a vocal note recognition result corresponding to a labeled vocal audio based on a synthesized audio generated from the labeled vocal audio and the accompaniment audio; the second network is configured to output a vocal note recognition result corresponding to the pure vocal audio based on a synthesized audio generated from the pure vocal audio and the accompaniment audio.

14. The method according to claim 13, wherein acquiring the note feature of the target audio by processing the audio feature using the vocal not recognition model comprises:
for each audio frame contained in the target audio, acquiring a first intermediate feature corresponding to the audio frame by processing the audio feature of the audio frame and contextual information of the audio feature of the audio frame by the vocal note recognition model;
extracting a second intermediate feature corresponding to the audio frame based on the first intermediate feature corresponding to the audio frame; and
acquiring a note feature corresponding to the audio frame based on the second intermediate feature corresponding to the audio frame and contextual information of the second intermediate feature corresponding to the audio frame;
wherein the note feature of the target audio comprises note features corresponding to each of the audio frames contained in the target audio.

15. The method according to claim 13, wherein acquiring the audio feature of the target audio comprises:
acquiring a frequency domain feature of the target audio by performing a time-frequency transform on the target audio; and
acquiring the audio feature of the target audio by filtering the frequency domain feature.

16. The method according to claim 13, wherein acquiring the vocal note sequence of the target audio by processing the note feature using the vocal note recognition model comprises:
acquiring the vocal note sequence of the target audio by classifying the note feature of the target audio by the vocal note recognition model.

17. The method according to claim 13, wherein the vocal note recognition model comprises an input layer, an intermediate layer, and an output layer; wherein
the input layer is configured to input the audio feature of the target audio;
the intermediate layer is configured to extract the note feature of the target audio based on the audio feature; and
the output layer is configured to acquire the vocal note sequence of the target audio based on the note feature.

18-19. (canceled)

20. A computer device comprising a processor and a memory having a computer program stored therein, wherein the processor, when executing the computer program, are caused to perform the method as defined claim 1.

21. A-transitory computer-readable storage medium having a computer program stored therein, wherein the computer program, when executed by a processor, causes the processor to perform the method as defined claim 1.

22. (canceled)

23. A computer device comprising a processor and a memory having a computer program stored therein, wherein the processor, when executing the computer program, are caused to perform the method as defined claim 13.
